(19) United States
(12) Patent Application Publication
(10) Pub. No.: US 2002/0046129 A1
(43) Pub. Date: Apr. 18, 2002

(54) Apparatus and technique for on-demand printing, and on-demand printing services

(76) Inventor: Shigeharu Nakagawa, Hiroshima (JP)

Correspondence Address: Robert E. Bushnell, Suite 300, 1522 K Street, N. W., Washington, DC, 20005, US

(21) Appl. No.: 09/874,010

(22) Filed: Jun. 6, 2001

(30) Foreign Application Priority Data
Oct. 13, 2000 (JP) 314284/2000

(51) Int. Cl. G06F 17/60

(52) U.S. Cl. 705/26

(57) ABSTRACT

Disclosed is a printing service that can be accessed by a customer through the World Wide Web over the Internet. Such a printing service is suitable for printing letters, illustrations, pictures, manuals, catalogs, text, research documents, images, reports and more. The printing service utilizes network printing to allow for printing of the final document(s) at a location convenient for the customer. The printing service quotes a price for a print job before the customer is obliged to use the printing service. The printing service has an editor to improve document quality before printing. Number of copies, type and size of paper, presence of a cover or a binding, and type and location of the output device are among a few of the attributes a customer may specify before printing. This service is particularly friendly to customers with small print jobs.

### CLAIM OF PRIORITY

This application makes reference to, incorporates the same herein, and claims all benefits accruing under 35 U.S.C. §119 from my application SYSTEM AND DEVICE FOR ON-DEMAND PRINTING, AND ON-DEMAND PRINTING SERVICES filed with the Japanese Patent Office on Oct. 13, 2000 and there duly assigned Ser. No. 314284/2000.

### BACKGROUND OF THE INVENTION

1. Field of the Invention

This invention relates to a printing service, and more particularly, a network printing service that can be accessed via the Internet.

2. Description of the Related Art

In the conventional off-set printing workflow, the user makes a draft copy of the printed product and orders the printing company to produce a printed product based on the draft copy made by the user. The printing company, once received the order, makes a draft copy for their own use based on the draft copy provided by the user, makes corrections on the draft copy several times, prints out the finalized draft copy, processes the printed product if necessary, such as binding the printed papers, and then deliver the finished printed product to the user.

U.S. Pat. No. 6,167,382 entitled Design and Production of Print Advertising and Commercial Display Materials Over The Internet to Sparks et al. discloses a commercial printing service that is accessible to a customer over the Internet that allows for the printing of images and text for advertising material to be printed at high resolution for the customer. However, Sparks et al requires a customer to choose an image to be printed from a library of templates having a finite number of images. Additionally, services like Sparks et al generally require the customer to order a large quantity or volume of the printed product. Furthermore, services like Sparks et al inconvenience the customer if the customer subsequently decides to make minor changes to the printed product. Also, services like Sparks et al do not provide for remote printing or network printing allowing the final product to be printed at a location convenient to the customer. Finally, the service of the Sparks et al patent does not provide for any necessary editing at the factory, such as font changes, correcting misspellings, typographical errors, unreadable characters due to different computer software programs or different font environment. What is needed is an Internet printing service that is more comprehensive, cost effective, customer friendly and overcomes the above aforementioned deficiencies.

### SUMMARY OF THE INVENTION

It is therefore an object of the present invention to provide an improved Internet network printing service for printing text, images and/or pictures.

It is also an object of the present invention to provide a printing service that is cost efficient, convenient and results in a quick turn around time for the customer.

It is further an object of the present invention to provide a printing service that caters to customers with low quantity print jobs by enabling the customer to order a low quantity print job at a low cost.

It is also an object of the present invention to provide a printing service that prints text, images and pictures at a high resolution, and to further provide for enlargement and reductions in size of an image submitted by a customer.

It is still further an object of the present invention to provide a printing service that allows the customer to choose the color, size, quality of paper to be used as well as the color of the ink to be used.

It is also an object of the present invention to provide a printing service that allows the customer to choose whether to bind printed documents and allows the customer choices of how to bind the printed documents.

It is further an object of the present invention to provide a printing service that can print at a high speed to allow for a quick turn around time for large, high volume orders.

It is yet another object of the present invention to provide an Internet printing service that can print at a remote location through network printing so that the finished product is printed at a location convenient to the customer.

It is further an object of the present invention to provide a printing service that can manufacture a cover for each document that is printed.

It is yet another object of the present invention to provide an Internet printing service that edits a document submitted by the customer to the printing service to correct misspellings, typographical errors, unreadable characters due to different computer software programs or different font environment, and to implement any of the customer requests such as type of font, font size, line spacing, justification, page numbering, fine and paragraph numbering, margins, headers/footers, layout of equations, etc.

It is also an object of the present invention to provide a price quote to a customer and allow the customer to accept the charges or rescind the transaction before the customer commits to having the print job executed by the printing service.

It is further an object of the present invention to provide a printing service where a customer can choose the type of output device (e.g., toner digital printer, CD-ROM printing device, ink-jet printer, magneto-optical disk read/write device, etc.).

It is also an object of the present invention to provide a printing service that allows a customer to easily make changes to a document submitted to the printing service for printing.

These and other objects can be achieved by providing a printing service that can be accessed by a customer through the World Wide Web over the Internet. Such a printing service is suitable for printing letters, illustrations, pictures, manuals, catalogs, text, research documents, and reports and more. The printing service is connected to a printing network to allow for printing of the final document(s) at a location convenient for the customer. A customer logs on to the Internet and types in the URL of the printing service. The printing service contains a home page whereby the customer can choose to place an order. The customer prints in a user's name, a password, E-mail address of the customer, paper size, number of pages, number of copies, presence or absence of a cover, type of binding if any, a file name of the document to be printed, and the user submits this information to the printing service. The customer may also specify the type of paper, the color of paper, the color of ink, the type of output device the document(s) are to be sent to, font information, fine spacing, margins and justification. In response to the customer's request, the printing service responds with a price quote. If the customer agrees to the price quote, the printing service receives the document(s) from the user over the Internet, edits the document(s), stores the edited document in a memory in case changes are later requested by the customer, and then sends the edited document through a printing network to the desired output device at the desired location. The customer is then notified by E-mail that the order has been processed. Being on the Internet and using network printing, the printing service can service many customers at many different locations at one time.

### BRIEF DESCRIPTION OF THE DRAWINGS

A more complete appreciation of the invention, and many of the attendant advantages, thereof, will be readily apparent as the same becomes better understood by reference to the following detailed description when considered in conjunction with the accompanying drawings in which like reference symbols indicate the same or similar components, wherein:

FIG. 1 is a block diagram illustrating an apparatus according to a first embodiment of the present invention;

FIG. 2 illustrates a printing process according to the first embodiment of the present invention;

FIG. 3 illustrates the cost estimate window according to the first embodiment of the present invention wherein a user requests a cost estimate;

FIG. 4 illustrates the cost estimate operation according to the first embodiment of the present invention wherein the user inputs detailed information used to determine the cost estimate;

FIG. 5 illustrates the cost estimate operation according to the first embodiment of the present invention wherein a editor is notified that the cost estimate has been requested;

FIG. 6 illustrates the cost estimate operation according to the first embodiment of the present invention wherein the user is notified of the cost estimate result;

FIG. 7 illustrates an operation panel according to the first embodiment of the present invention wherein the user connects a user's terminal to a printing information input processor;

FIG. 8 illustrates the operation panel according to the first embodiment of the present invention wherein the user inputs the document having text, images and pictures;

FIG. 9 illustrates the operation panel according to the first embodiment of the present invention wherein the user confirms the document having text, images and pictures inputted by the user;

FIG. 10 illustrates the operation panel according to the first embodiment of the present invention wherein the editor receives the document having text, images and pictures provided by the user;

FIG. 11 illustrates an example of a controlled file according to the first embodiment of the present invention created by the editor so as to record edited document having text, images and pictures;

FIG. 12 is a block diagram illustrating apparatus used according to a second embodiment of the present invention; and

FIG. 13 illustrates a printing process according to the second embodiment of the present invention.

### DETAILED DESCRIPTION OF THE INVENTION

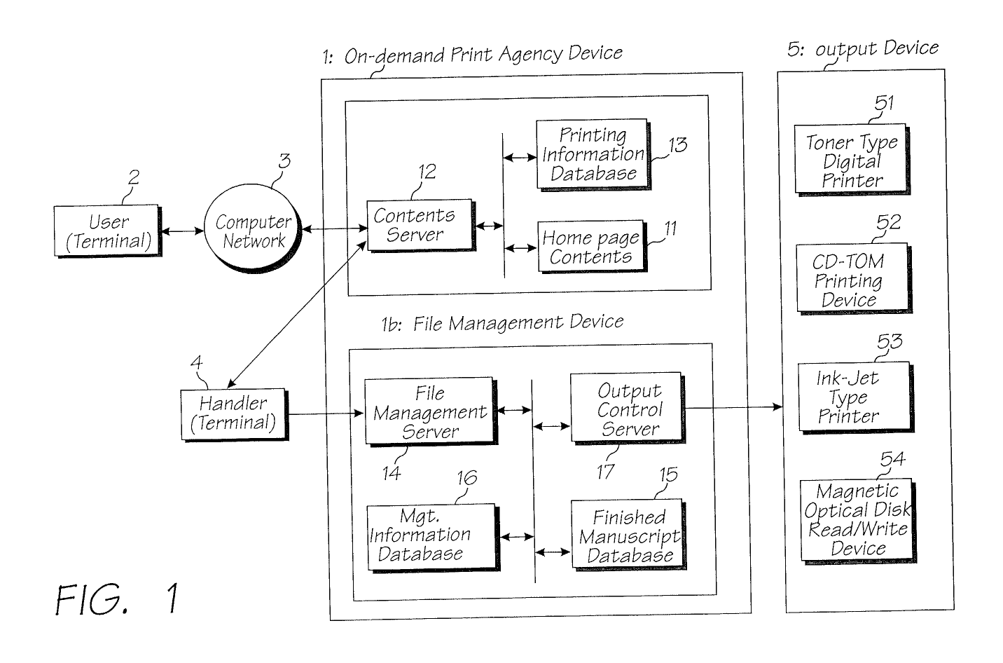

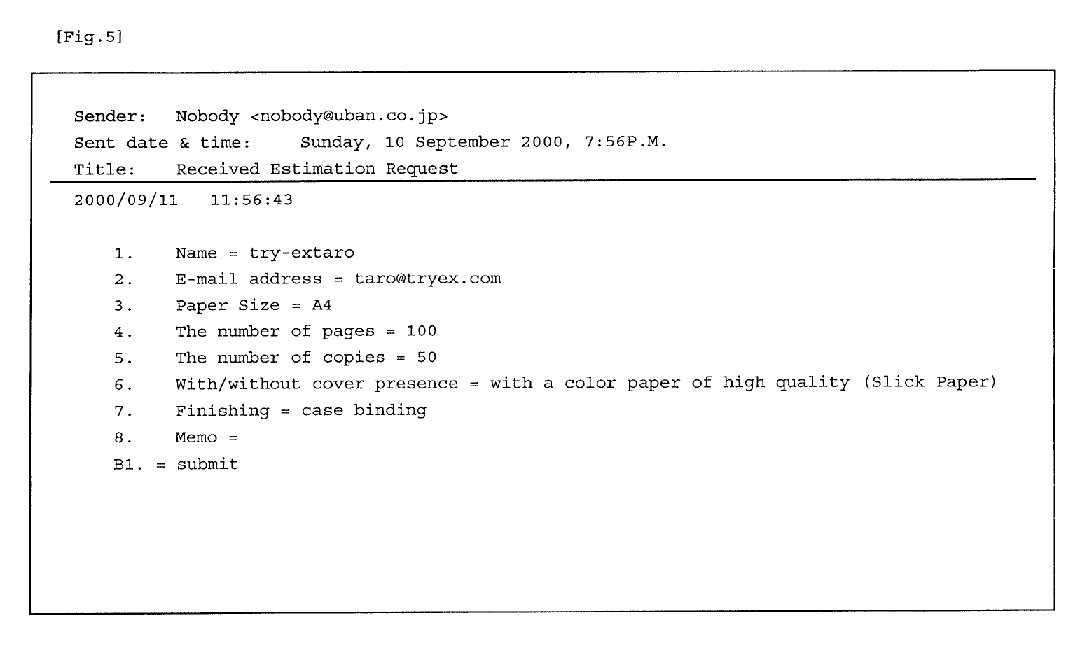

Turning to the Figures, FIGS. 1-11 pertain to the first embodiment of the present invention. Turning to FIG. 1, FIG. 1 is a block diagram illustrating the apparatus of the first embodiment. In FIG. 1, reference numeral 1 shows an on-demand printing supporting device of the present invention. Numeral 2 is a customer at a customer's computer terminal (hereinafter “customer”) who obtains, via on-demand printing supporting device 1, a printed product on which a document having text, images and pictures is recorded on the customer's desired printing material. Numeral 3 illustrates a computer network, represented by Internet, which connects on-demand printing device 1 to customer 2. Numeral 4 illustrates an editor that revises and/or changes a draft copy of the document provided by the customer 2. Editor 4 is made up of operation terminals which can be connected to on-demand printing supporting device 1. Numeral 5 illustrates an output device which stores document having text, images and pictures provided by the customer via on-demand printing supporting device 1, and records the document having text, images and pictures on a printing medium desired by the customer. It is noted that the device included in the output device 5 can be either one of toner-type digital printer 51, CD-Page ROM printing machine 52, ink jet type printer 53 or magneto-optical disk read/write machine 54. Also, there can be more than one customer 2 in computer network 3.

The on-demand printing supporting device 1 consists of homepage provider 1a for providing homepage (contents information provided by the World Wide Web (WWW) server) and file management device 1b for controlling the document having text, images and pictures provided by the customer. Further, homepage provider 1a is made up of homepage contents 11, contents server 12 and a document having text, images and pictures in a printing information database 13, while file management device 1b is made up of file management server 14, a database 15 having the finalized document including text, images and pictures, controlled information database 16 and output controller 17. Homepage contents 11 records homepage information provided by the homepage provider 1 to customer 2.

Contents server 12 enables customer 2 and/or editor 4 to input information based on the information recorded in homepage contents 11, and sends information to customer 2 and/or editor 4. Printing information database 13 records, according to the ID number of customer 2, a document having text, images and pictures inputted by customer 2 from the a customer terminal via computer network 3 in accordance with the instructions given by contents server 12.

File management server 14 enables file management device to record the document having text, images and pictures retrieved by editor 4 from the printing information database 13 via contents server 12 and edited by editor 4 as a finalized document having text, images and pictures, and controlled information as controlled file. The finalized document having text, images and pictures in finalized document database 15 records controlled files of finalized document having text, images and pictures inputted by editor 4. Output controller 17 controls the finalized document having text, images and pictures output to output device 5. Homepage contents 11, the document having text, images and pictures in printing information database 13, the finalized document having text, images and pictures in finished manuscript database (or finalized document database) 15, and controlled information database 16 can be non-volatile memories such as hard disk devices, magneto-optical disk devices, flash memory, etc., and volatile memories, such as RAM (Random Access Memory) or, of a computer readable/writable storage medium which is a combination of any of the aforesaid memory devices. The performance of contents server 12, file management server 14 and output controller 17 can be achieved by a hardware set solely for its own purpose or, a CPU (central processing unit) in which the memory may be loaded with specific programs to achieve the desired performances.

An input device, a display device, etc. (not shown in figures) are connected as peripheral devices to on-demand printing supporting device 1. Here, a keyboard, a mouse, etc. are used as the input devices. Also, CRT (Cathode Ray Tube) display device, liquid crystal display, etc. are used as the display device.

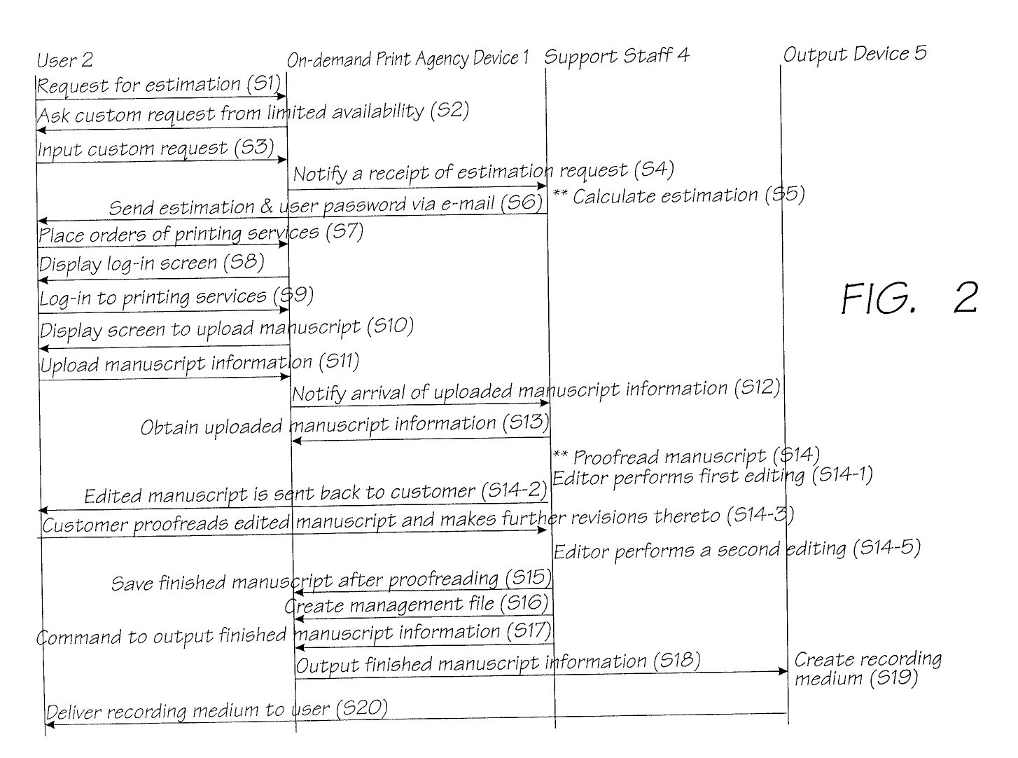

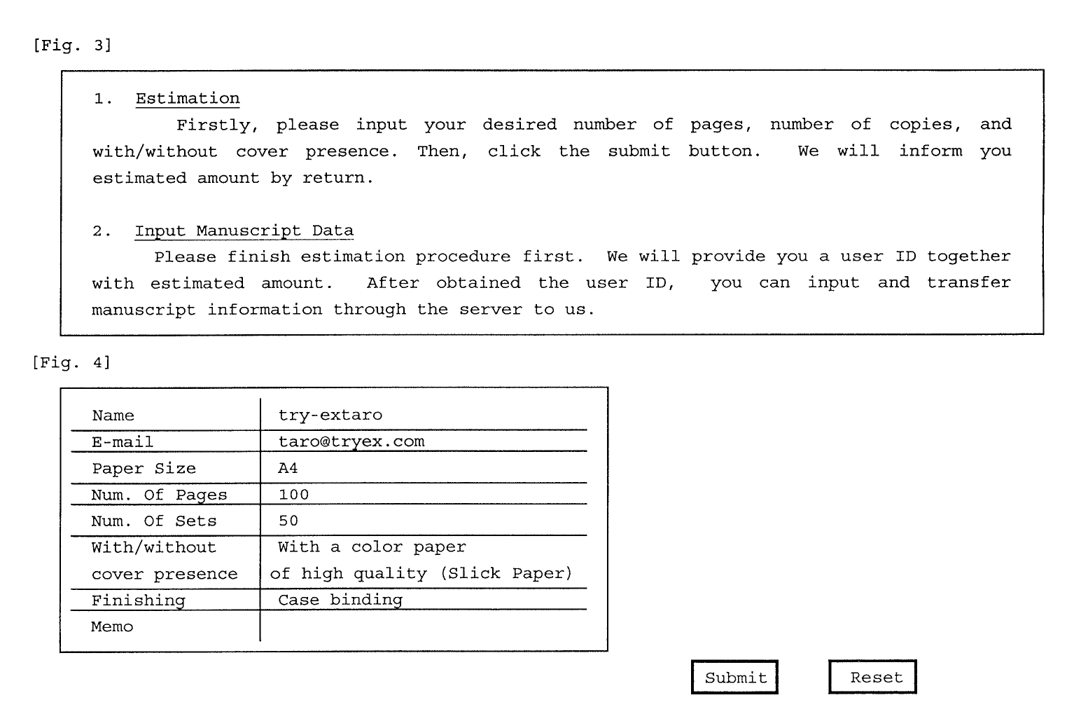

FIG. 2 is a flow diagram illustrating the process of the present invention. In FIG. 2, content server 12 in the on-demand printing supporting device 1 requests customer 2 to make, from the customer terminal, a cost estimate request (S1), and the cost estimate request is notified to the on-demand printing supporting device 1 when the customer makes selection on the menu posted on the homepage which is provided by contents server 12 (FIG. 3).

Contents server 12 displays in the customer terminal, an input operation screen (shown in FIG. 4), notifies customer 2 of menu selection necessary to make the cost estimate (S2), and requests customer 2 to actually make the selection in accordance with the displayed instructions (S3). FIG. 4 shows the selections for document having text, images and pictures in a certain format. This information represents the printed products which the document having text, images and pictures outputted from output device 5 is recorded on the printing medium. The selection is made by inputting the various information such as paper size, number of pages, type of binding, if any, (binding by stapler, by binder, or by wrapper), whether or not a cover is to be present, type of recording media, (e.g., printing by color sheet of fine quality (super-thick type), color sheet of fine quality (Resak)), number of copies, name and e-mail address for notifying the cost estimate. A second form requesting further information from the customer may then be displayed. This form can include, but is not limited to, asking the user what color of paper is to be used in the printing process, what location does the customer want his document or manuscript to be printed, the type of output device the customer wishes his document or manuscript to be printed on (such as toner type digital printer, CD-ROM printing device, ink-jet type printer or magnetic optical disk read/write device), enlargement or reduction information for images and/or pictures, font type, font size, page margins, line spacing, page numbering, justification, printing on one side of a piece of paper or printing in duplex. All of this information is sent to the on-demand printing supporting device 1 by clicking the “submit button”.

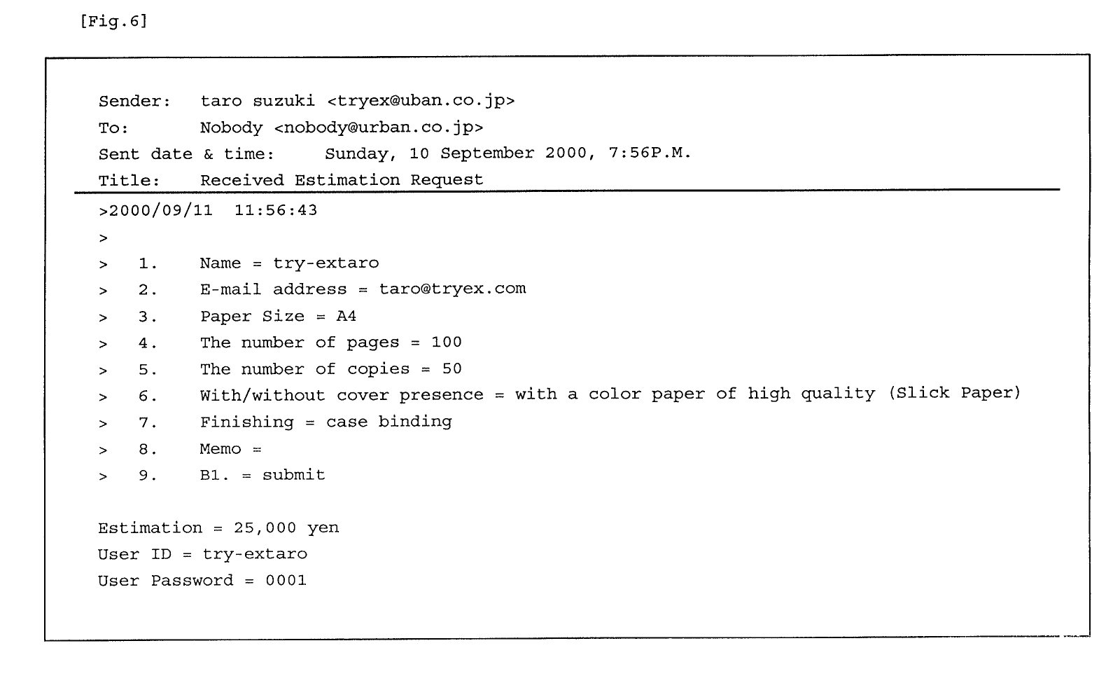

When the above selections have been made, contents server 14 notifies editor 4 that the cost estimate request has been inputted (S4). Editor 4 is notified, via e-mail, of receipt of the cost estimate request, and the editor makes cost estimate (S5). The cost estimate made by the editor then is sent to customer 2 from the editor terminal via contents server 12 in a form of email as shown in FIG. 6 (S6). The e-mail containing the cost estimate made by the editor also contains a customer ID and a customer password which are necessary for customer 2 to access to the document having text, images and pictures located in contents server 12. Unlike other printing services, this service does not offer substantial “volume discounts” based on the size of the document to be printed or the quantity of the documents to be printed. For this reason, editor can quote an exceptionally low cost for both high volume orders and for small orders attracting both high volume customers and low volume customers.

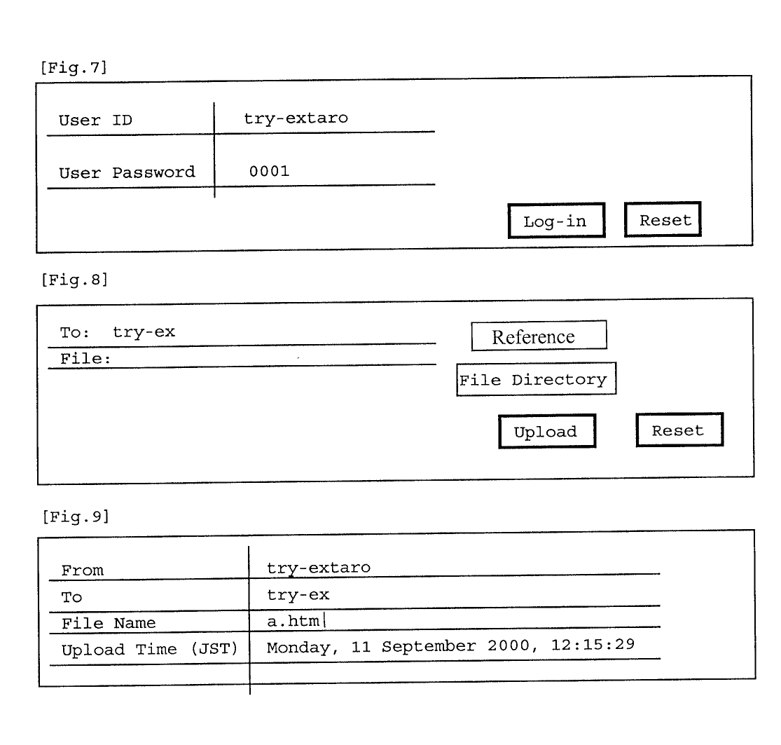

Upon receipt of the estimate cost, client ID and client password, the customer 2 requests submission of document having text, images and pictures (log into printing service) by selecting “2. Data Submission” menu on the homepage provided by contents server 12 (S7), as shown in FIG. 3. Contents server 12 displays on the customer's terminal an operation panel for connecting the customer's terminal to the document having text, images and pictures processor of contents server 12, as shown in FIG. 7 (S8). The customer 2 then inputs into the operation panel the client ID and client password previously received. The customer's terminal then is connected to the document having text, images and pictures processor by depressing the “log-in” button (S9). Contents server 12 then displays on the customer's terminal an input screen for inputting the document having text, images and pictures (S10) as shown in FIG. 8. Customer 2 then selects an appropriate document having text, images and pictures displayed by a certain data format in the customer's terminal by depressing the “reference button” under “file directory” on the screen as illustrated in FIG. 8. The document having text, images and pictures is then inputted to contents server 12 by depressing “upload” button on the screen (S11). Here, PDF (Portable Document Format) with which the same image on the customer's terminal can be obtained on the printing material, or the markup language, html (Hyper Text Markup Language), are preferable as a data format for document having text, images and pictures.

Contents server 12 records the document having text, images and pictures, together with the customer's client ID, in the printing information database 13, and then notifies the editor 4 that the document having text, images and pictures has been received (S12). Receipt of document having text, images and pictures can be found by editor 4 either by periodically accessing contents server 12 by editor 4, or by notifying editor 4 by contents server 12 upon receipt of document having text, images and pictures. Editor 4 then retrieves the document 4 having text, images and pictures from the document having text, images and pictures in printing information database 13 via contents server 12 (S13).

FIG. 10 illustrates one example of the operation in which editor 4 retrieves the document having text, images and pictures via contents server 12. FIG. 10 also illustrates a “Download” button for retrieving the document having text, images and pictures, a “Delete” button for deleting the document having text, images and pictures from the printing information database, as well as a list of uploaded document information having text, images and pictures. In FIG. 10, “From” stands for an address where the document having text, images and pictures has been received from (to contents server 12), “To” stands for an address where the document having text, images and pictures has sent to (from contents server 12), “Real Name” stands for the type of the document having text, images and pictures sent or received, and “Upload Time” stands for a time period for uploading a document having text, images and pictures, Editor 4 then downloads the document having text, images and pictures necessary in accordance with the instructions set forth on the operation panel. The process of editing may include changes made to the document at the request of the customer, or may include changes initiated by the print agency itself. Editing can include but is not limited to correcting misspellings, correcting typographical errors, correcting unreadable characters that can be caused by different computer software programs used by the customer and the print agency or different font environments, formatting the document such as page margins, page numbering, line numbering, paragraph numbering, line spacing, insertion of headers and footers, change of fonts or font size, enlargement or reduction of a size of an image or picture, formatting equations.

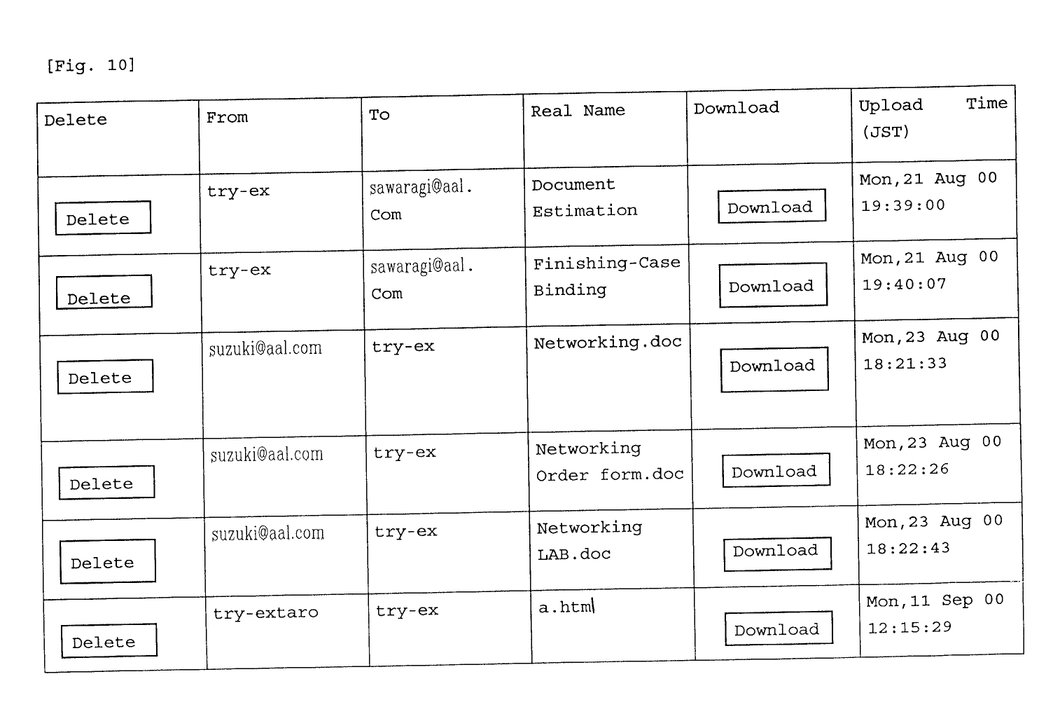

For example, in FIG. 9, “try-extaro” has sent a document having text, images and pictures under filename “a” in a HTML format; column “From” shows “try-extaro”, column “Real Name” shows “a.htm”. Editor 4 retrieves the document having text, images and pictures and then edits the received document having text, images and pictures (S14). The edited document having text, images and pictures is inputted to file management server 14 by editor 4, and then sends the edited document having text, images and pictures to the finished manuscript database 15 (S15). Other embodiments include the steps of editing the document having text, images and pictures sent by the customer by editor 4 (S14-1), submitting the edited version to the customer for further revisions and proofreading(S14-2), having the customer proofread said document (S14-3), having the customer resubmit the proofread document back to the print agency(14-4), and then performing a second editing by the editor 4(S14-5) before the document is stored in the finalized document database 15. If no editing job is necessary, the document having text, images and pictures received by editor 4 can be sent to finalized document database from printing information database 13 as a finalized document having text, images and pictures.

File management server 14 receives from editor 4 controlled printing information as a control file for controlling an edited document having text, images and pictures, and records that information in controlled (or management) information database 16 (S16). FIG. 11 illustrates contents of a control file created by editor 4. FIG. 11 illustrates record contents in the control file made by editor 4. This is also a control file in the case where a recording medium is output to an output device 5 specifying bound print, name of the sales person, information on the customer (category and name), date when complete manuscript information was made, name and parts/reference number of the complete manuscript file, the language used in complete manuscript information, number of pages, price per page, size of the print copy, quality of a cover, paper quality of the text, print information on the cover, text print information, print color of the cover, binding style, binding method, name of support staff, data form of the manuscript (kind of the manuscript), control number of the recording medium (e.g. an optical magnetic disk such as MO etc. and a tape) which records complete manuscript information in electronic data format, etc.

After file management server 14 has recorded a complete document having text, images and pictures in finalized document database 15, and has recorded a control file in controlled information database 16, editor 4 gives instructions (S17) to output controller 17 to output the finalized edited document having text, images and pictures to output device 5. (S18). At this point, when output device 5 includes a plurality of devices, (e.g. toner digital printer 51, CDROM printing device 52, ink-jet printer 53, magneto-optical disk read/write device 54, etc.,) editor 4 selects an appropriate output device.

Then, output device 5 records the document having text, images and pictures on a recording medium desired by the customer(for example, a printed and bound product or a CDROM) (S19). The final printed products will be delivered to customer 2 via delivery means such as mail, private home delivery services, etc. (S20). The output devices are capable of outputting 180 sheets per minute and may or may not comprise digital output devices.

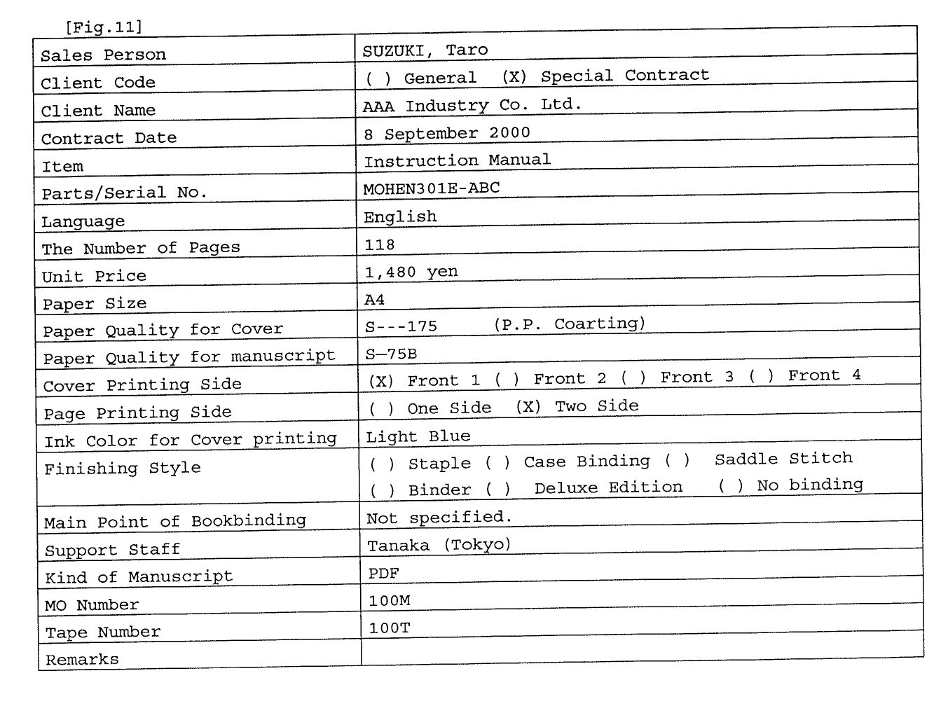

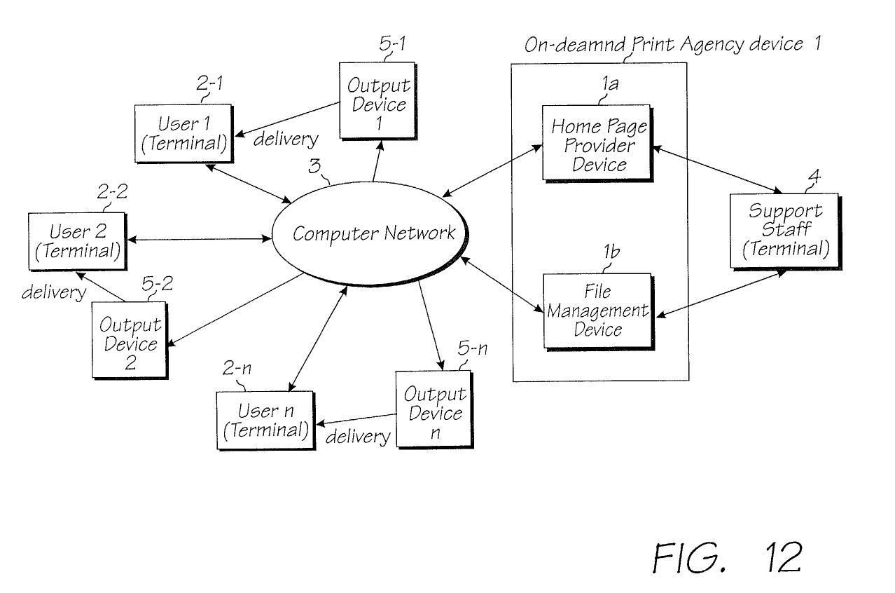

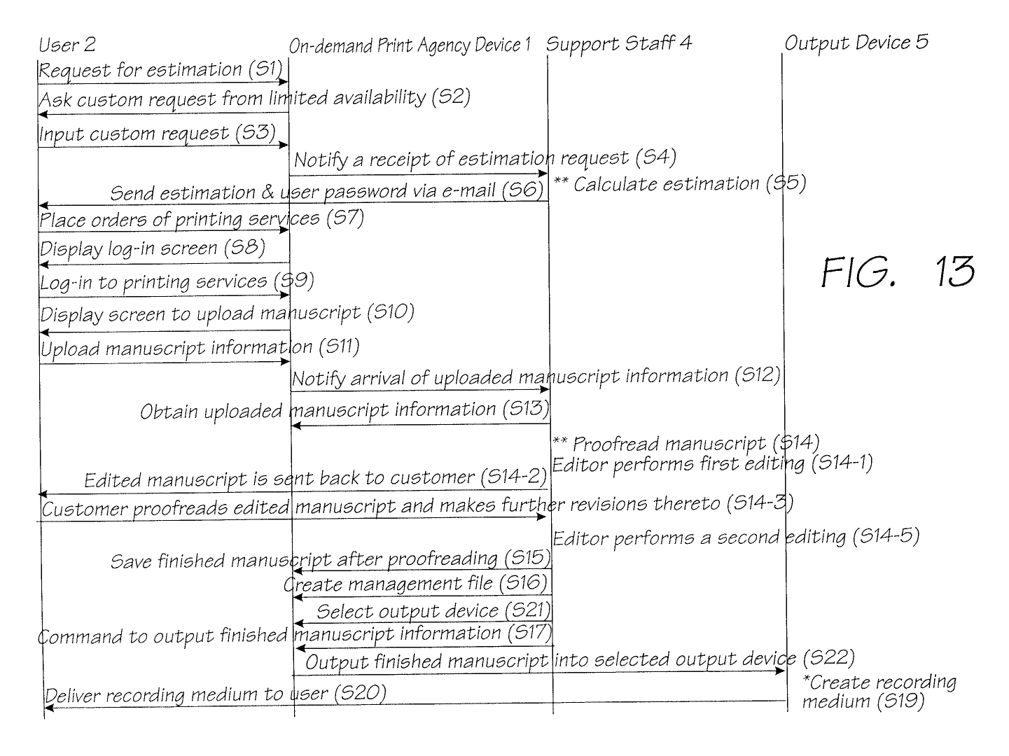

Referring to FIG. 12 and the second embodiment of the present invention, the elements illustrated in FIG. 12 bearing the same reference numeral numbers as the elements illustrated in FIG. 1, perform the same functions as the elements illustrated in FIG. 1 bearing the same reference numeral numbers found in FIG. 12. As to the reference numeral numbers not found in FIG. 1, that is, 2-1˜2-n, this represents a plural number of customers and 5-1˜5-n represents a plural number of output devices which are connected to computer network 3, with which the document having text, images and pictures provided by the customers are recorded, via the on-demand printing support system, on the printing medium desired by the customers via network printing. As explained in the first embodiment above, output devices 5-1 through 5-n can be toner-type digital printer 51 which electronically gathers pages in order, CD-ROM printing machine 52, inkjet type printer 53, magneto-optical disk read/write machine 54, etc. Devices to be included in output device 5 may be one of the followings: toner-type digital printer 51 which electronically gathers pages in order, CD-ROM printing machine 52, inkjet type printer 53, magneto-optical disk read/write machine 54, etc.

As shown in FIG. 12, “1 through n” shown next to numeral numbers 2 corresponds to the same number “1 through n” which appears nest to 5. For example, output device 5-1 is used for recording the document having text, images and pictures on a desired printing medium desired by customer 2-1, output device 5-2 is used for recording the document having text, images and pictures on a desired printing medium desired by customer 2-2, and output device 5-n is used for recording the document having text, images and pictures on a desired printing medium desired by customer 2-n. This is an example of network printing. As output devices are located nearby their customers for their convenience, if customer 2-1 is located in the Hokkaido region in Japan, output device 5-1 is also located in the Hokkaido region in Japan. Similarly, if customer 2-2 is located in the Kyushu region in Japan, output device 2-2 is also located in the Kyushu region in Japan. Likewise, a customer can be located in New York, Chicago, Los Angeles, London, Seoul, etc. As a result, output devices will be located at these various locales around the world for the convenience of the customer. It may be necessary for a set of output devices (toner type digital printer, CD-ROM printing device, ink-jet type printer and magnetic optical disk read/write device) to be located at each of these locales. These output devices must be regularly maintained as they must be loaded with the various sizes, colors and quality of paper at all times in order to print any and all orders received by the printing agency.

Referring now to FIG. 13, FIG. 13 is a flow diagram for the second embodiment of the present invention. In FIG. 13, the elements illustrated in FIG. 13 bear the same step numbers as the elements illustrated in FIG. 2 and perform the same functions as the step numbers illustrated in FIG. 1. With respect to the step numbers (S18) which are not shown in FIG. 2, when file management server 14 records the finalized document having text, images and pictures in finalized document database 15, the edited document having text, images and pictures in conjunction with the control information in controlled information database 16 are output by output controller 17 after editor 4 selects an output device (S21). Editor 4 then selects an output device which is located nearest the customer. For example, if the document having text, images and pictures is provided by customer 2-1, then editor 4 selects output device 5-1, and if the document having text, images and pictures is provided by customer 2-2, editor 4 selects output device 5-2. Upon selection of an output device, output controller 17 outputs, in accordance with the instructions provided by editor 4 (S17), the edited document having text, images and pictures to the selected output device (S22). The selected output device records the document having text, images and pictures on the recording medium desired by the customer (bound printed material or CD-ROM) (S19), and the finished products are shipped to the customer 2 by mail or other delivery means (S20).

As mentioned above, the document having text, images and pictures inputted by the customer is recorded, via the on-demand printing supporting system, on the printing medium. It is noted that the owner of the on-demand printing supporting system may record the document having text, images and pictures which the owner holds the copyright, on a printing medium via the on-demand printing supporting system, and delivers the printed products to its customer. The printed product may be printed on a machine near the customer via network printing.

It is further noted that a computer system may be used to function as the on-demand printing supporting system described above, by recording the programs necessary to function the on-demand printing supporting system in the computer readable recording medium so as to store the recorded programs in the computer system.

The aforesaid computer system includes hardware, such as OS or peripheral devices. When the WWW (World Wide Web) system is used, homepage providing environment (or, display environment) is also included. Also, the aforesaid computer readable recording medium are memory devices stored in a computer system, such as floppy disks, magneto-optical disks, ROMs, CD-ROMs, or storage devices. Further, the aforesaid computer readable recording medium includes transmission media or transmission wave, for example, which keeps the programs actively for a short time as transmitting the programs via computer networks, such as Internet, and communication lines, such as telephone lines. Also, volatile memory installed inside a computer system which is to be a server or a client, for example, may be included in the aforesaid computer readable recording medium, which keeps the programs for a certain time,

It is further noted that the above-described programs may be enable part of the on-demand printing supporting system described above. Also, the programs may a so-called “differential program” which can be combined with programs which have already been stored in the computer system so as to function as a complete on-demand printing supporting system.

What is claimed is:

1. An Internet printing apparatus, comprising:
a home page that can be accessed by a customer over the World Wide Web, said home page comprising instructions of how a customer can request a print job, said home page further comprising a form that may be accessed through a hyperlink, said form enabling a customer to request said print job;
a first memory storing a customer's printing parameters and a first draft of said customer's print job;
an editor connected to said first memory to edit said first draft of said customer's print job creating a finalized version of said customer's print job;
a second memory connected to said editor storing said finalized version of said customer's print job; and
an output device connected to said second memory via network printing to download said finalized version onto a recording media at a location of said customer's choice.

2. The apparatus of claim 1, wherein said customer's first draft and said finalized version of said customer's print job comprises text, images and pictures.

3. The apparatus of claim 1, wherein said printing parameters comprise:
size of paper to be printed on;
color of paper to be printed on;
quality of paper to be printed on;
quantity to be printed;
whether or not to print a finished cover page;
whether or not to bind each document printed and a type of binding to be used; and
type and location of output device.

4. The apparatus of claim 1, further comprised of said output device being selected from the group consisting of a toner type digital printer, a CD-ROM printing device, an ink-jet type printer; and a magnetic optical disk read/write device.

5. The apparatus of claim 1, further comprised of said customer selects said output device from the group consisting of a toner type digital printer, a CD-ROM printing device, an ink-jet type printer; and a magnetic optical disk read/write device.

6. The apparatus of claim 1, further comprised of said output device being selected from the group consisting of a toner type digital printer, a CD-ROM printing device, an ink-jet type printer; and a magnetic optical disk read/write device.

7. The apparatus of claim 1, further comprised of said output device comprising a plurality of devices including a toner type digital printer, a CD-ROM printing device, an ink-jet type printer; and a magnetic optical disk read/write device.

8. The apparatus of claim 1, wherein editing comprises changes made by said editor to said first draft submitted by said customer over said Internet to said first memory, said changes include changes specified by said customer and changes initiated by said editor.

9. The apparatus of claim 8, wherein editing comprises correcting misspellings, correcting typographical errors, and correcting unreadable characters due to different software computer programs and different font environment.

10. The apparatus of claim 1, wherein said output device prints 180 sheets per minute.

11. A method for printing text, images and pictures, comprising the steps of:
connecting, via the Internet, a customer at a computer terminal to a printing agency;
filling out a print request form by said customer and submitting said print request form over the Internet to said printing agency;
receiving a cost estimate from said printing agency;
transmitting a first draft of a customer's print job comprising text, images and pictures from said customer's computer to said printing agency over the Internet and storing said first draft in a first memory;
editing said first draft of said customer's print job at said print agency and storing a resulting document in a second memory; and
outputting said document from said second memory to a remote output device of the customer's choice.

12. The method of claim 11, wherein said request form asks the customer a number of pages in said first draft, the quantity to be printed, a paper size, whether or not a cover is to be made, and whether or not each document is to be bound.

13. The method of claim 12, wherein said request form further asks said customer the color and quality of the paper to be printed on, the type of binding if any, the location of where the documents are to be printed out, and the type of output device the documents are to be printed out on.

14. The method of claim 11, wherein said editing step is comprised of:
correcting misspellings;
correcting typographical errors; and
correcting unreadable characters due to different computer software programs or different font environment.

15. The method of claim 14, wherein said editing step is further comprised of formatting page margins, line spacing, font size, page numbering, line numbering, and paragraph numbering.

16. The method of claim 11, wherein said editing step is comprised of enlarging or reducing images and pictures of said first draft of said customer's print job.

17. The method of claim 11, wherein said editing step is comprised of the steps of:
conducting a first editing by said printing agency of said first draft of said customer's print job;
sending said edited first draft of said customer's print job back to the customer over the Internet;
conducting a further revisions to said print job by said customer;
sending said revised print job back to the printing agency;
conducting a second editing by said printing agency to said revised print job to produce a finalized document; and
storing said finalized document in said second memory at said printing agency.

18. The method of claim 11, wherein said output device can be a toner type digital printer, a CD-ROM printing device, an ink-jet printer or a magnetic optical disk read/write device.

19. The method of claim 11, further comprising a first plurality of output devices located at a second plurality of locations distant from said printing agency, said first plurality of output devices being connected by network printing to said second memory of said printing agency that stores said document for output.

20. A system for printing a document having text, images and pictures, comprising:
a user computer terminal connected to the Internet;
a printing agency accessible via the Internet by said user computer;
an editor connected to said printing agency for editing a manuscript submitted by said user to said printing agency to produce said document having text, images and pictures; and
a first plurality of output devices located at a second plurality of locations distant from said printing agency, each of said first plurality of output devices connected to said printing agency via computer network printing.

21. The system of claim 20, wherein said printing agency comprises:
a first memory for storing a manuscript originally submitted by said user prior to editing; and
a second memory for storing said finalized document after editing.

22. The system of claim 20, wherein a second plurality of users are transmitting and receiving data and revisions of a plurality of manuscripts simultaneously from said printing agency.

23. The system of claim 20, wherein said first plurality of output devices comprise:
toner type digital printers;
CD-ROM printing devices;
ink-jet type printers; and
magnetic optical disk read/write devices.

24. The system of claim 20, wherein said first plurality of output devices print at a rate of 180 sheets per minute.
